(19) United States
(12) Patent Application Publication
(10) Pub. No.: US 2006/0073085 A1
(43) Pub. Date: Apr. 6, 2006

(54) Anion generator

(75) Inventors: Yaogang Chen, Xi An City, Shanxi Province (CN); Zhijun Hou, Xi An City, Shanxi Province (CN)

Correspondence Address: BIRCH STEWART KOLASCH & BIRCH, PO BOX 747, FALLS CHURCH, VA, 22040-0747, US

(73) Assignee: XI'AN KONG HONG INFORMATION TECHNOLOGY CO.

(21) Appl. No.: 10/542,441

(22) PCT Filed: Jun. 5, 2003
(86) PCT No.: PCT/CN03/00439

§ 371 Date: Jul. 15, 2005

(30) Foreign Application Priority Data
Apr. 24, 2003 (CN) 03114683.X

(51) Int. Cl. B01J 19/08; B01J 19/12

(52) U.S. Cl. 422/186.21; 422/186; 422/186.04

(57) ABSTRACT

The anion generator of the present invention is mainly composed of casing, interior circuit, ion emitting head etc. The casing comprise insulating case and conducting protective grille, the interior circuit mainly comprise power circuit and oscillation boosting circuit. The power circuit is comprised of AC power supply circuit and DC power supply circuit, which supply power for the oscillation boosting circuit alternately through change-over switch. The oscillation boosting circuit is composed of oscillation circuit, boosting circuit and multilevel dual voltage circuit. The character of the present invention is that, the conducting protective grille fixed on the casing has charge, so the diffusion of anion is accelerated; the said boosting circuit employs sheet piezoelectric ceramic transformer for boosting, which is simple in structure, small in volume and without protective circuit; and protective resistance is connected between the multilevel dual voltage circuit and ion emitting head. The circuit, casing and conducting protective grille of the invention is novel , so it's small and no protective circuit, high boosting ratio, safe and stabilized, low electromagnetic interference, fireretardant. The present invention could be used for the production of air-conditioner, vehicular and household electric appliances, beautification and health protection etc.

### BACKGROUND

1. Field of the Invention

The present invention relates to anion generator. More particularly, the present invention relates to an efficient and diffusible anion generator, which is comprised of a sheet piezoelectric ceramic transformer to generate high voltage, a multilevel dual voltage circuit to further increase the high voltage, and an anion emitting head connected therewith to generate high-tension electric-field in order to ionize air, thus producing a great deal of anion, which will be quickly, efficiently diffused out when it is passing through a casing with conducting protective grille. The field of the invention belongs to the electronic technology field.

2. Description of Related Art

It is well known that anion generators can purify environment, produce fresh air, and are of benefit to human's health and can treat some diseases taking as an auxiliary means.

At present, conventional anion generator is composed of a casing, a interior circuit mounted in said casing and an anion emitting head. The interior circuit generates high voltage to make the anion emitting head connected with the interior circuit to generate high-tension electric-field in order to ionize air, thus producing a number of anion which will escape through the window set on the casing depending on diffusion or fanner and then combine with dust and bacteria in air to make them settle in order to purify air and kill the bacteria.

The core portion of an anion generator is a interior circuit which is used for generation of high voltage to make the anion emitting head connected therewith to generate high-tension electric-field in order to ionize air thus producing a number of anion. Ionizing air to produce ion needs an operating voltage ranging from several kilovolts to tens kilovolts. The interior circuit of a conventional anion generator generates a high-tension electric-field by means of a conventional wound transformer, and this claims the wound transformer to have very high boosting ratio, while the dielectric strength of primary and secondary winding of the transformer and that between turns of secondary winding to be very high, so that its process technology is complex, its cost is high and its failure rate is rising, resulting in breakdown between turns and short-circuit, even burning and other catastrophic results. Besides, an insulant is covered on the surface of the casing of conventional anion generator, (for example, the plastic casing, or due to coating process, metallic casing isolated with other parts become a non-conductor.). In this case, anion focuses on the escaping window and when focused to a certain degree it will form a barrier with negative charge which will prevent the anion from escaping, so that the anions produced by the anion generator are within the casing of the generator only and can not reach to air, decreasing its function greatly. This results in the casing of anion generator acts only as a protection for interior circuit while the high density anion within the casing can escape out to outside only through diffusion or fanning by means of an electric fan, most of anion is dampened through separation or absorption of the casing so that the practical employment effect is bad.

### SUMMARY

In view of foregoing reasons, the objective of the invention is to provide an efficient, diffusible anion generator which has small volume, no short-circuit protection, high boosting ratio, simple insulation construction, safe and stabilized, low electromagnetic interference.

To implement above objective, the invention adapts following technical scheme:

An anion generator, which includes casing, interior circuit, ion emitting head and a discharge resistance;

Said casing is composed of insulating case and conducting protective grille, the conducting protective grille is connected to a certain potential;

Said interior circuit is composed of power circuit and oscillation boosting circuit, the power circuit provides operating power of the oscillation boosting circuit; the oscillation boosting circuit is composed of oscillation circuit, boosting circuit and multilevel dual voltage circuit, the function of oscillation boosting circuit is to generate high-tension used to ionize air though an ion emitting head;

Said ion emitting head is a discharge probe or discharge brush; the ion emitting head is connected with the high-tension output terminal of the multilevel dual voltage circuit in the oscillation boosting circuit;

a discharge resistance is connected between said conducting protective grille and the interior circuit.

Said conducting protective grille may be manufactured as a separate element, or be done integrally with other portion of the casing. Said conduction protective grille can be made of conductive metallic materials or semi-conducting materials, or else be made of other non-metallic materials treated by special process to have certain conductivity.

Said boosting circuit is composed of a sheet piezoelectric ceramic transformer.

Said power circuit includes AC power supply circuit and DC power supply circuit, between which there is a change-over switch, which can be switched to supply power for said oscillation boosting circuit.

Said oscillation circuit is mainly composed of resistances, composite triodes and inductors; as the loop capacitance of the oscillation circuit, the input capacitance of the sheet piezoelectric ceramic transformer of said boosting circuit is connected between the base electrode and collecting electrode of composite triode, so that the oscillation circuit with sheet piezoelectric ceramic transformer can form self-oscillation.

Through a protective resistance, said ion emitting head is connected to the high-tension output terminal of multilevel dual voltage circuit in said oscillation boosting circuit.

Viewing from above description, the invention has following advantages:

1. As certain electric potential is applied to the conducting protective grille, an electric field is formed on the casing of anion generators. The electric field accelerates the escape velocity of anions, while the discharge resistance releases a few anion absorbed by the protective grille in time, to make the grille maintaining at a certain potential, so that the anion can efficiently escape into air and its density at 30 cm away from the grille is more than 3×10⁶/cm³, and this not only purifies air but also performs disinfection, thus solving the problem, i.e. the existing anion generator is ineffective when ion escapes away from the casing, greatly improving the availability of the ion generator.

2. As the interior circuit uses sheet piezoelectric ceramic transformer to generate high voltage, differing from conventional wound transformer, the invention is high boosting ratio, small in volume, simple in insulation, safe and stabilized, and low electromagnetic interference.

3. The invention is simple in structure, safe, stable and reliable, and has no short-circuit protection and a few component. It can be used in refrigerators, air-conditioners, and other household appliances, and vehicular and personnel health protection series products.

### BRIEF DESCRIPTION OF THE DRAWINGS

These and other features, aspects, and advantages of the present invention will become better understood with regard to the following description, appended claims, and accompanying drawings where:

FIG. 1 is a structural scheme of the invention; and

FIG. 2 is a specific diagram of interior circuit of the invention.

### DETAILED DESCRIPTION

To further understand the invention, the invention will be described in particular with the drawings as follows:

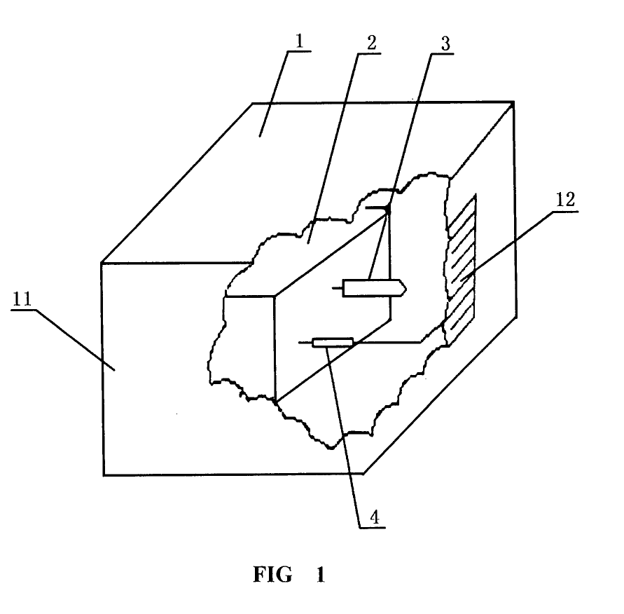

As shown in FIG. 1, an efficient and diffusible anion generator according to the invention comprises a casing 1, interior circuit 2, ion emitting head 3, discharge resistance 4,etc.

The casing 1 is composed of insulating case 11 and conducting protective grille 12 embedded in the case 11. A certain voltage is applied to the conducting protective grille 12 to form an electric field on the casing 1, the object of which is to accelerate the escape of ions produced in the anion generator. The conducting protective grille 12 is made of conducting metallic materials or semi-conducting materials, or some non-metallic materials which is treated by special process so as to have a certain conductivity. The conducting protective grille 12 can be formed as a separate component, or integrality with other part of the casing 1.

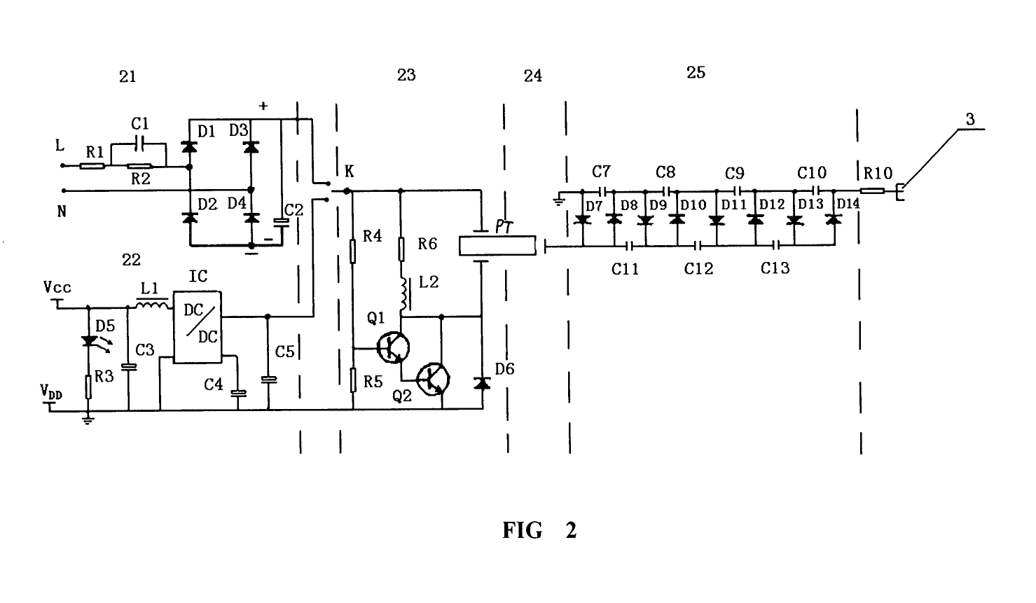

As shown in FIG. 2, the interior circuit 2 is comprised of power circuit and oscillation boosting circuit. The power circuit is composed of AC power supply circuit 21 and DC power supply circuit 22 (including dry cell), which can be switched into oscillation boosting circuit to supply power by means of a switch K. The oscillation boosting circuit is comprised of oscillation circuit 23, boosting circuit 24 and multilevel dual voltage circuit 25, in which the oscillation circuit 23 is a typical oscillation circuit and the boosting circuit 24 is mainly comprised of a sheet piezoelectric ceramic transformer. The oscillation circuit 23 can provide energy for the sheet piezoelectric ceramic transformer in boosting circuit 24, to resonate the piezoelectric ceramic transformer to produce high-tension, the high-tension produced by transformer is again increased through a multilevel dual voltage circuit 25 and then is applied to the ion emitting head 3 connected with the interior circuit 2.

The ion emitting head 3 is comprised of a discharge probe or discharge brush. When a high-tension is applied to the ion emitting head 3, the ion emitting head 3 generates high-tension electric-field to ionize air, thus produce a number of anion.

To accelerate the diffusion and escape of anion within the anion generator, certain voltage is applied to the conducting protective grille 12 in the casing 1, and in order to maintain the potential of the conducting protective grille 12 in stable, a discharge resistance 4 is placed between conducting protective grille 12 and interior circuit 2. The discharge resistance 4 should have a necessary insulation voltage and certain resistance value in correspondence with the voltage existing on the anion generator.

FIG. 2 is a particular circuit diagram of the interior circuit 2 of the invention.

The interior circuit 2 is comprised of power circuit and oscillation boosting circuit. The power circuit is composed of alternating-current power supply circuit 21 and direct-current power supply circuit 22 ( including dry cell), and the oscillation boosting circuit is comprised of oscillation circuit 23, boosting circuit 24 and multilevel dual voltage circuit 25.

Said AC power supply circuit 21 is composed of resistance R1, R2, capacitor C1, and diode rectifier bridges D1˜D4, and filter capacitor C2. Said DC power supply circuit 22, including dry cell, is composed of D5, R3, L1, C3, and direct-current conversion chip IC, i.e. IC device used specially for DC/DC conversion, and capacitor C4, C5. AC power supply circuit 21 and DC power supply circuit 22 can be switched by means of a change-over switch K to supply power for oscillation circuit 23.

Said oscillation circuit 23 is composed of R4, R5, R6, Q1, Q2, L2, D6, in which, R6 is a discharged resistance of the oscillation circuit, and D6 is a protected diode.

Said boosting circuit 24 is comprised of a sheet piezoelectric ceramic transformer PT.

Said multilevel dual voltage circuit 25 is composed of diodes D7˜D14, capacitor C7˜C13. The number of stage of the boosting circuit 25 can be increased or decreased in accordance with the requirement for the output voltage of boosting circuit 24, in order to apply an output voltage up to several kilovolts to the ion emitting head 3.

Multilevel dual voltage circuit 25 is connected to the ion emitting head 3 through a protective resistance R10.

When AC voltage (for example ˜220 v or ˜110 v) is applied to the efficient diffusible anion generator, the terminal L (phase line) is connected to one input of diode rectifier bridges D1˜D4 through a reducing resistance R1, current-limiting capacitor C1 and resistance R2; the terminal N (zero line) is connected to another input of diode rectifier bridges D1˜D4. Output of diode rectifier bridges D1˜D4 is connected to the switch K through filter capacitor C2, to output corresponding DC voltage for oscillation circuit 23.

When DC voltage (for example dry cell) is applied to the efficient diffusible anion generator, the DC voltage will applied to the voltage input terminal of IC chip through C3, L1 of peripheral circuit of chip IC. After (DC/DC) conversion by IC chip, the output direct-current voltage of IC chip is maintained at certain value in constant so that the IC chip acts as a regulated power supply. The voltage output terminal of IC chip is connected with switch K through filter capacitor C4,C5. Due to switching by change-over switch K, the anion generator can operate under AC voltage, or DC voltage.

When DC voltage is applied to oscillation circuit 23 by means of change-over switch K, it provides a biasing voltage for triode Q1, Q2 through a biasing circuit which is composed of R4 and R5, so that the triode Q1, Q2 turn on and the sheet piezoelectric ceramic transformer PT is operating.

The input capacitor of the sheet piezoelectric ceramic transformer PT, as a loop capacitance of oscillation circuit 23, provides a feedback signal for the base of triode Q1 form a self-oscillation, the frequency of which is close to that of mechanical resonance of the sheet piezoelectric ceramic transformer PT. The duplex tube comprising triode Q1, Q2 acts as oscillation, amplification and energy provision, which provides input energy for sheet piezoelectric ceramic transformer PT. Receiving the driving power from oscillation circuit, the sheet piezoelectric ceramic transformer PT generates N times of output voltage and transmits it to the multilevel dual voltage circuit 25. Though protective resistance R10, the output voltage of the multilevel dual voltage circuit 25 is applied to the ion emitting head 3 connecting with the interior circuit 2. When high-tension is applied to the ion emitting head 3, a high-tension field is formed which ionizes air to produce a number of anion which escapes from the conducting protective grille 12 and combines with dust and bacteria in the air, thus purifying air and killing the bacteria.

Additional variations and modifications of the preferred embodiment described above may also be made as will be appreciated by those skilled in the art and accordingly the above description of the present invention is only illustrative in nature. The invention is further defined by the following claims.

1. An anion generator, which includes casing, interior circuit, ion emitting head and a discharge resistance;
Said casing is composed of insulating case and conducting protective grille, the conducting protective grille is connected to a certain potential;
Said interior circuit is composed of power circuit and oscillation boosting circuit, the power circuit provides operating power of the oscillation boosting circuit; the oscillation boosting circuit is composed of oscillation circuit, boosting circuit and multilevel dual voltage circuit, the function of oscillation boosting circuit is to generate high-tension used to ionize air though an ion emitting head;
Said ion emitting head is a discharge probe or discharge brush; the ion emitting head is connected with the high-tension output terminal of the multilevel dual voltage circuit in the oscillation boosting circuit;
a discharge resistance is connected between said conducting protective grille and the interior circuit:

2. An anion generator as in claim 1, said conducting protective grille may be manufactured as a separate element, or be done integrally with other portion of the casing.

3. An anion generator as in claim 2, said conduction protective grille can be made of conductive metallic materials or semi-conducting materials, or else be made of other non-metallic materials treated by special process to have certain conductivity.

4. An anion generator as in claim 2, said boosting circuit is composed of a sheet piezoelectric ceramic transformer.

5. An anion generator as in claim 4, said power circuit includes AC power supply circuit and DC power supply circuit, between which there is a change-over switch, which can be switched to supply power for said oscillation boosting circuit.

6. An anion generator as in claim 5, said AC power supply circuit is composed of reduce-limiting current circuit, diode rectifier bridges and filter capacitor.

7. An anion generator as in claim 6, said oscillation circuit is mainly composed of resistances, composite triodes and inductors;
as the loop capacitance of the oscillation circuit, the input capacitance of the sheet piezoelectric ceramic transformer of said boosting circuit is connected between the base electrode and collecting electrode of composite triode, so that the oscillation circuit with sheet piezoelectric ceramic transformer can form self-oscillation.

8. An anion generator as in claim 7, said multilevel dual voltage circuit is composed of diode D7˜D14 and capacity C7˜C14.

9. An anion generator as in claim 8, through a protective resistance, said ion emitting head is connected to the high-tension output terminal of multilevel dual voltage circuit in said oscillation boosting circuit.

10. An anion generator as in claim 3, said boosting circuit is composed of a sheet piezoelectric ceramic transformer.
